(19) United States
(12) Patent Application Publication
(10) Pub. No.: US 2014/0222324 A1
(43) Pub. Date: Aug. 7, 2014

(54) LIVE TRAFFIC VIEW

(71) Applicant: ZF Friedrichshafen AG, Friedrichshafen (DE)

(72) Inventors: Ronald Muetzel, Hawthorn Woods, IL (US); Thomas Roesch, Friedrichshafen (DE)

(21) Appl. No.: 13/758,914

(22) Filed: Feb. 4, 2013

(51) Int. Cl. G08G 1/00

(52) U.S. Cl. CPC G08G 1/00
USPC 701/118; 701/117; 701/119

(57) ABSTRACT

A traffic condition detection system is provided for accessing traffic detection units and obtaining traffic data from the accessed traffic detection units. By analyzing the obtained traffic data, an end to a traffic congestion pattern may be estimated.

### BACKGROUND OF THE INVENTION

1. Field of the Invention

The invention relates to a traffic condition detection system. The traffic condition detection system is capable of analyzing traffic data and determining a traffic condition based on the analyzed traffic data.

2. Related Art

Travelers can utilize various technologies, such as GPS (Global Positioning Satellite) technology, to better plan and route one or more paths to a given destination. However, simply knowing the available paths to the destination does not necessarily help the traveler arrive at the destination any faster. This is because each path may come with its own unique traffic conditions that will impact the traveler's travel time.

Therefore, there is a need for a system that can better determine traffic conditions at various locations along the user's intended path.

### SUMMARY OF THE INVENTION

The descriptions below include apparatuses and methods for providing a system that is capable of analyzing traffic data and determining traffic conditions at various locations based on the traffic data.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The embodiments described below may be more fully understood by reading the following description in conjunction with the drawings, in which

FIG. 1 illustrates a traffic condition detection system according to some embodiments of the present invention;

FIG. 2 illustrates a traffic condition detection system according to some embodiments of the present invention;

FIG. 3 illustrates a traffic condition detection system according to some embodiments of the present invention;

FIG. 4A illustrates a flow chart describing a process for determining a traffic condition according to some embodiments of the present invention;

FIG. 4B illustrates a flow chart describing a close up view of a process described in FIG. 4A for determining a traffic condition according to some embodiments of the present invention;

FIG. 5A illustrates a flow chart describing a process for determining a traffic condition according to some embodiments of the present invention;

FIG. 5B illustrates a flow chart describing a close up view of a process described in FIG. 5A for determining a traffic condition according to some embodiments of the present invention; and

FIG. 6 illustrates a block diagram of a multi-media module, according to some embodiments of the present invention.

### DETAILED DESCRIPTION

The present invention as described herein may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein.

The present invention relates to a traffic condition detection system. More specifically, the present invention relates to a user within the traffic condition detection system who is able to utilize one or more components within the traffic condition detection system in order to detect a traffic congestion condition. By determining a location of the traffic congestion condition, the user may be able to plan a trip that avoids the detected traffic congestion condition.

In addition, for the cases where the user already finds him/herself in a traffic congestion condition, the user is able to utilize one or more components of the traffic condition detection system in order to determine an end location to the traffic congestion condition. By locating an end to the traffic congestion condition that the user is currently stuck in, the user may make a more informed decision as to whether to remain on the current route, or re-direct to a different route having lower traffic congestion.

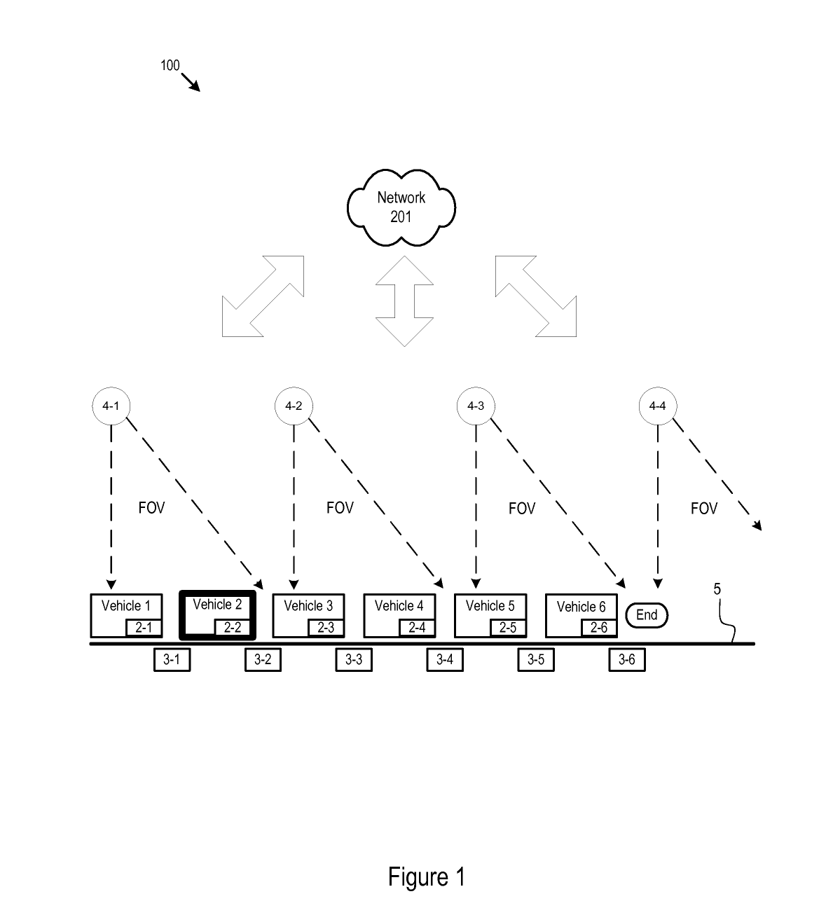

FIG. 1 illustrates a traffic condition detection system 100 according to some embodiments of the present invention. A traffic condition detection system 100 may correspond to a predetermined area, a city, a metropolitan area, a state, or any other similarly definable area. The traffic condition detection system 100 is illustrated as including a plurality of vehicles 1-6. The number of vehicles illustrated in FIG. 1 is for exemplary purposes only, as the traffic condition detection system 100 may include a greater, or lower, number of vehicles than the six vehicles expressly illustrated in FIG. 1. For exemplary purposes, the present embodiment may be described from the viewpoint of a user driving vehicle 2, although any one of the vehicles may be referenced. Vehicle 2 has been highlighted in FIG. 1 accordingly.

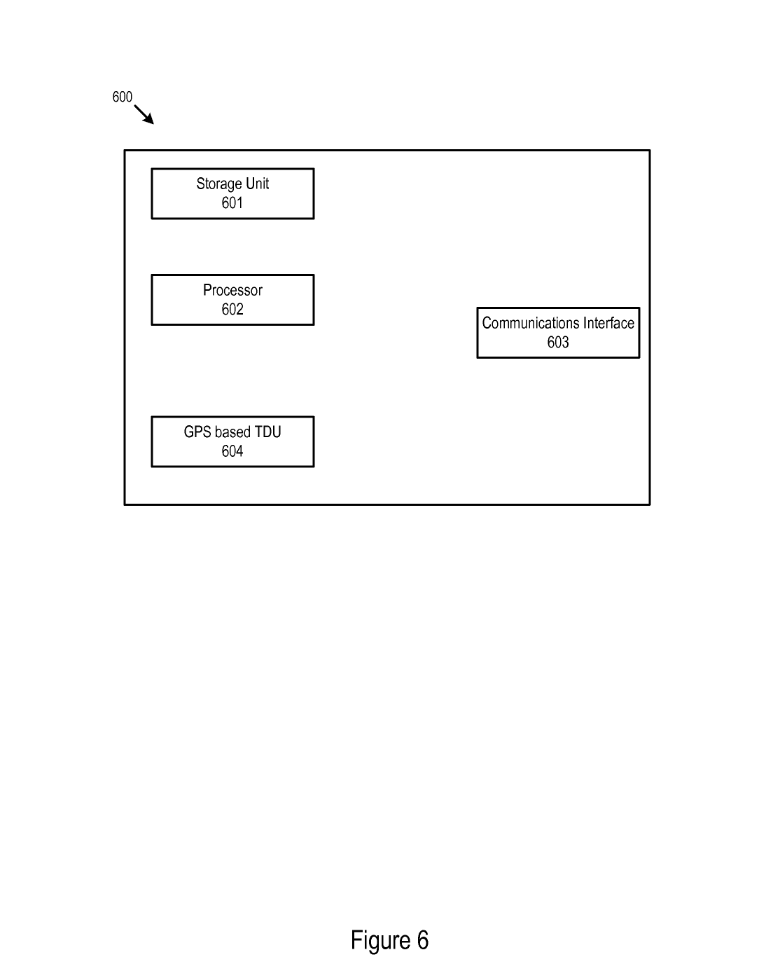

The user's vehicle 2 may be equipped with a multi-media module (MMM) 600 as illustrated in FIG. 6. The MMM 600 may include a storage unit 601, processor 602, communications interface 603, and, optionally, a GPS-based traffic detection unit (TDU) 604. An MMM located in vehicle 2 may communicate with a TDU via the network 201 provided as part of the traffic condition detection system 100. For instance, the MMM located in vehicle 2 may request traffic data from GPS-based TDUs 2-1, 2-2, 2-3, 2-4, 2-5, 2-6, or from road sensor TDUs 3-1, 3-2, 3-3, 3-4, 3-5, 3-6 or from traffic light TDUs 4-1,4-2, 4-3, 4-4 via the network 201. Further description is provided later in this disclosure.

The network 201 may include one or more wired networks, wireless networks, or combinations thereof. For example, network 201 may be a cellular network, including standards-based networks (e.g., 2G, 3G, Universal Mobile Telecommunications System (UMTS), GSM® Association, Long Term Evolution (LTE)™, or more), WiMAX, Bluetooth, WiFi (including 802.11 a/b/g/n/ac or others), WiGig, Global Positioning System (GPS) networks, and others available at the time of the filing of this application or that may be developed in the future. Further, the network may be a public network, such as the Internet, a private network, such as an intranet, or combinations thereof, and may utilize a variety of networking protocols now available or later developed including, but not limited to TCP/IP based networking protocols. Further description for the vehicle MMM is provided later in this disclosure.

The traffic condition detection system 100 is also illustrated as including a plurality of different types of TDUs. One type of TDU illustrated in FIG. 1 is a GPS-based TDU that may be included on a vehicle as part of the vehicle's MMM. Alternatively, the GPS-based TDU may be included in the vehicle independent from the vehicle's MMM. For instance, the GPS-based TDU may be included in a cellular phone of a passenger in the vehicle. In either case, each GPS-based TDU may communicate with a GPS satellite (not illustrated) via the network 201 illustrated in FIG. 1 in order to obtain a variety of different location related information.

For instance, FIG. 1 illustrates each of the vehicles 1-6 including respective GPS-based TDUs 2-1, 2-2, 2-3, 2-4, 2-5, and 2-6. If the user in vehicle 2 desires to know the location of vehicle 2, the MMM from vehicle 2 may transmit a request to the GPS satellite via the network 201. After receiving the location request from the MMM, the GPS satellite may track the GPS-based TDU 2-2 in vehicle 2 and determine a location of the GPS-based TDU 2-2 based on the tracking information. The GPS satellite may then return the corresponding location information of the GPS TDU 2-2 back to the MMM in vehicle 2. Because the GPS-based TDU 2-2 is included in vehicle 2, the information locating the GPS-based TDU 2-2 may also be considered to be the vehicle 2 location. In this way, the user is able to obtain a location of vehicle 2.

In addition or alternatively, the MMM in the user's vehicle 2 may obtain the location of one or more other GPS-based TDUs within the traffic condition detection system 100 or otherwise accessible by the GPS satellite. For instance, the MMM may send a request to the GPS satellite for the location of GPS-based TDU 2-4. Then the GPS satellite may track GPS-based TDU 2-4 in order to determine the location of GPS-based TDU 2-4. The GPS satellite may then return the location information of GPS-based TDU 2-4 back to the MMM.

The MMM in vehicle 2 may present the obtained location information of either vehicle 2 itself or of other GPS-based TDUs to the user. The MMM may also reference the location information as part of an analysis of traffic data in order to determine traffic conditions at specific locations. Further description of how traffic data, such as vehicle location information, may be referenced in order to determine traffic conditions will be provided later in this disclosure.

The MMM in vehicle 2 may also be capable of obtaining traveling speed information for vehicle 2 via the GPS satellite. In order to accomplish this, a request may be sent from the MMM to the GPS satellite to determine a traveling speed of the GPS-based TDU 2-2. After receiving the request and tracking the GPS-based TDU 2-2, the GPS satellite may determine a traveling speed of the GPS-based TDU 2-2 and return the determined traveling speed information back to the MMM in vehicle 2. Because the GPS-based TDU 2-2 is included in vehicle 2, the speed of the GPS-based TDU 2-2 may be considered to be the speed of vehicle 2. Alternatively, the MMM in vehicle 2 may be capable of determining the speed of vehicle 2 based a calculation of speed using time and location information provided by the GPS satellite.

In addition or alternatively, the MMM in vehicle 2 may obtain the traveling speed of one or more other GPS-based TDU within the traffic condition detection system 100 or otherwise accessible by the GPS satellite. For instance, the MMM may send a request to the GPS satellite for the traveling speed of GPS-based TDU 2-4. Then the GPS satellite may track GPS-based TDU 2-4 in order to determine the speed of GPS-based TDU 2-4. The GPS satellite may then return the traveling speed information of GPS TDU 2-4 back to the MMM.

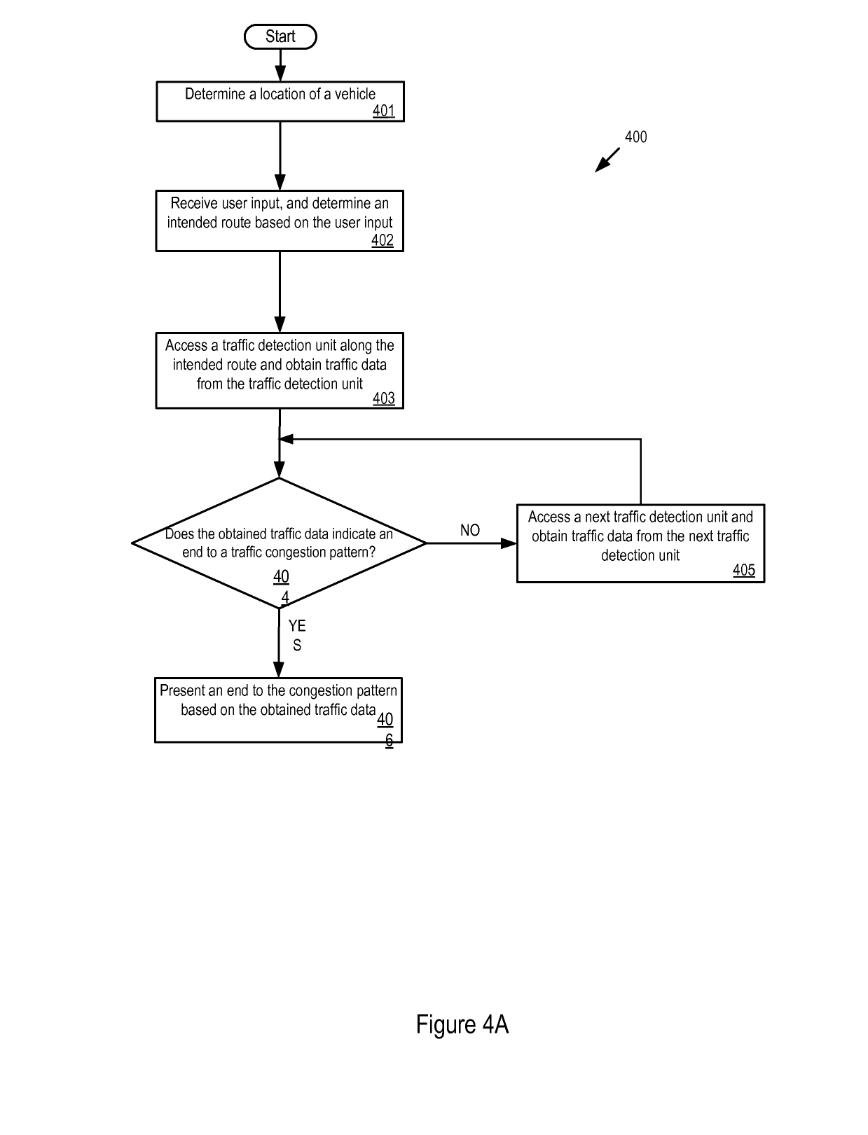

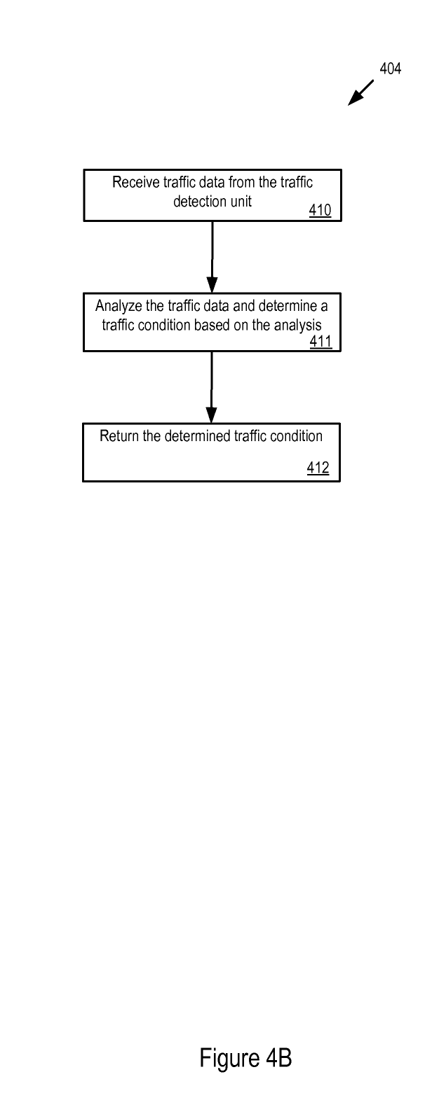

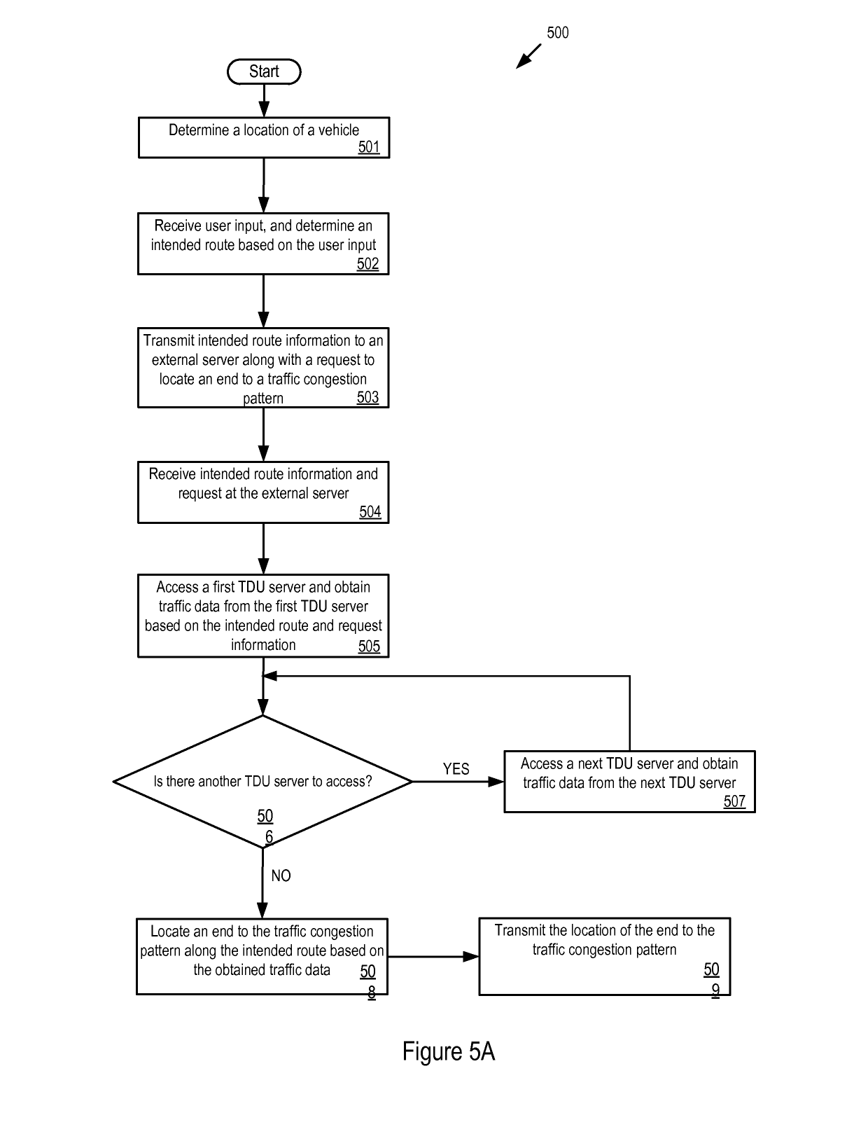

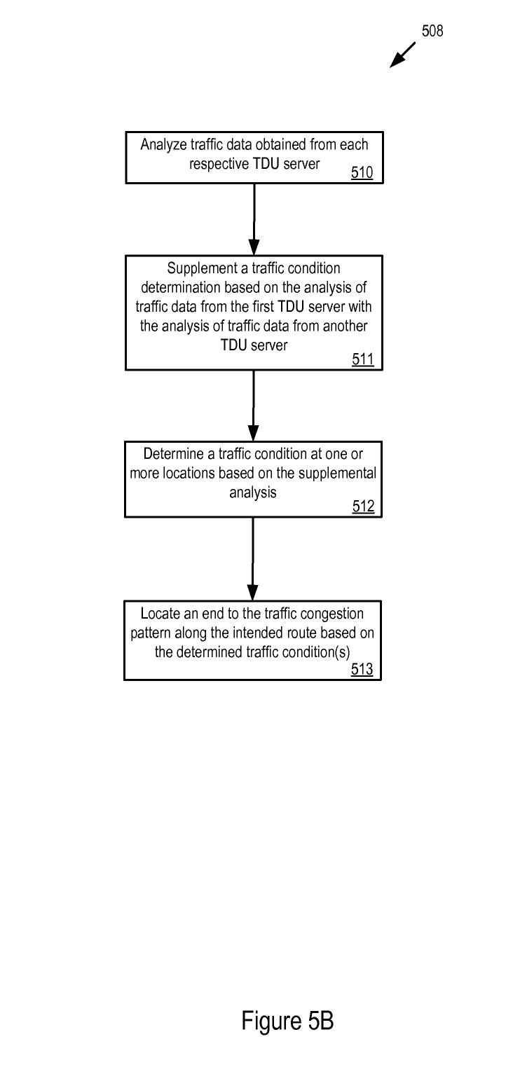

The MMM in vehicle 2 may present the obtained traveling speed information to the user. The MMM may also reference the traveling speed traffic data as part of an analysis of traffic data as described later with reference to the processes illustrated in FIGS. 4 and 5.

The number of GPS-based TDUs illustrated in FIG. 1 is provided for illustrative purposes only. The traffic condition detection system 100 may include a greater, or lower, number of GPS-based TDUs than illustrated in FIG. 1. In addition, although all of vehicles 1-6 are illustrated in FIG. 1 as including a GPS-based TDU, not all vehicles within the traffic condition detection system 100 may include a GPS-based TDU.

Another type of TDU is a road sensor TDU. FIG. 1 illustrates road sensor TDUs 3-1, 3-2, 3-3, 3-4, 3-5 and 3-6. Each road sensor TDU may be placed under a road 5 that is within the traffic condition detection system 100. A road sensor TDU may be comprised of a pressure or stress detection type sensor that is able to detect when a vehicle passes over the road sensor TDU. A road sensor TDU may also include components for determining a speed at which a vehicle passes over the road sensor TDU based on the measurement information detected from the road sensor TDU as the vehicle passes over. In this way, when a vehicle rolls over a road sensor TDU, the road sensor TDU may collect traffic data by measuring a speed of the vehicle as it passes over the road sensor TDU.

In addition or alternatively, the road sensor TDU may collect traffic data by measuring a rate at which vehicles pass over the road sensor TDU. In any case, the user in vehicle 2 may provide inputs into the MMM in vehicle 2 in order to request traffic data from one or more of the road sensor TDUs in the traffic condition detection system 100.

For instance, the user may provide an input into the MMM in vehicle 2 requesting the MMM to obtain traffic data from road sensor TDU 3-4. The MMM may then generate a request for traffic data, and transmit the request to road sensor TDU 3-4. After receiving the request for traffic data, the road sensor TDU 3-4 may then transmit traffic data measured by road sensor TDU 3-4 back to the MMM. The MMM may present the traffic data to the user. The MMM may also reference the traffic data as part of an analysis of traffic data as later described by the processes illustrated in FIGS. 4 and 5.

The number of road sensor TDUs illustrated in FIG. 1 is provided for illustrative purposes only. The traffic condition detection system 100 may include a greater, or lower, number of road sensor TDUs than illustrated in FIG. 1.

Another type of TDU is a traffic light TDU. FIG. 1 illustrates traffic light TDUs 4-1, 4-2, 4-3, and 4-4. Each traffic light TDU may be placed at traffic lights within the traffic condition detection system 100. A traffic light TDU may be comprised of a camera component for recording a scene that plays out within a field of view (FOV) of the camera. The traffic light TDU may also include a storage unit (e.g., memory) that is configured to store video data captured by the camera of the traffic light TDU. In this way, when a vehicle moves within a FOV of the traffic light TDU, the traffic light TDU may record the vehicle as it passes through the FOV of the traffic light TDU. In this way the traffic light TDU is able to capture and record vehicles as they move past the FOV of the traffic light TDU. Alternatively, a TDU may be placed on a road sign, building, utility pole, or any stationary object. Thus, in the present description, traffic light TDU may refer to a TDU attached to some object other than a traffic light.

The user in vehicle 2 may provide inputs into the MMM in vehicle 2 in order to request video data from one or more of the traffic light TDUs in the traffic condition detection system 100. For instance, the user may provide an input into the MMM in vehicle 2 requesting the MMM to obtain video data from traffic light TDU 4-4. The MMM may then generate a request for video data, and transmit the request to traffic light TDU 4-4. After receiving the request for video data, the traffic light TDU 4-4 may then transmit video data recorded by the traffic light TDU 4-4 back to the MMM. The MMM may present the video data to the user by playing back the video data recorded by traffic light TDU 4-4 via the MMM. The MMM may include a display component for displaying the traffic data. In addition or alternatively, the MMM may transmit the traffic data to another display that is located within the vehicle 2.

The MMM may also perform video processing on the video data obtained from the traffic light TDU 4-4 in order to generate traffic data. For example, the video data obtained from traffic light TDU 4-4 may be subjected to video processing that is able to detect a traveling speed for vehicles that pass through the FOV of traffic light TDU 4-4. The video data obtained from traffic light TDU 4-4 may also be subjected to video processing that is able to detect a rate at which vehicles pass through the FOV of traffic light TDU 4-4. The video data obtained from traffic light TDU 4-4 may also be subjected to video processing that is able to detect a density of vehicles that are within the FOV of traffic light TDU 4-4. The traffic data generated by any one of the video processing methods described above may be referenced by the MMM as part of an analysis of traffic data as later described by the processes illustrated in FIGS. 4 and 5.

It should be noted that the list of traffic data that may be generated from the video processing of the video data obtained from the traffic light TDUs is provided for exemplary purposes only, as other types of traffic data may also be generated. Also, in alternative embodiments the video processing described may be executed on the traffic light TDUs such that the MMM need only request and receive from the traffic light TDU the traffic data that is generated from the processed video data on the traffic light TDU. Also, the number of traffic light TDUs illustrated in FIG. 1 is provided for illustrative purposes only. The traffic condition detection system 100 may include a greater, or lower, number of traffic light TDUs than illustrated in FIG. 1.

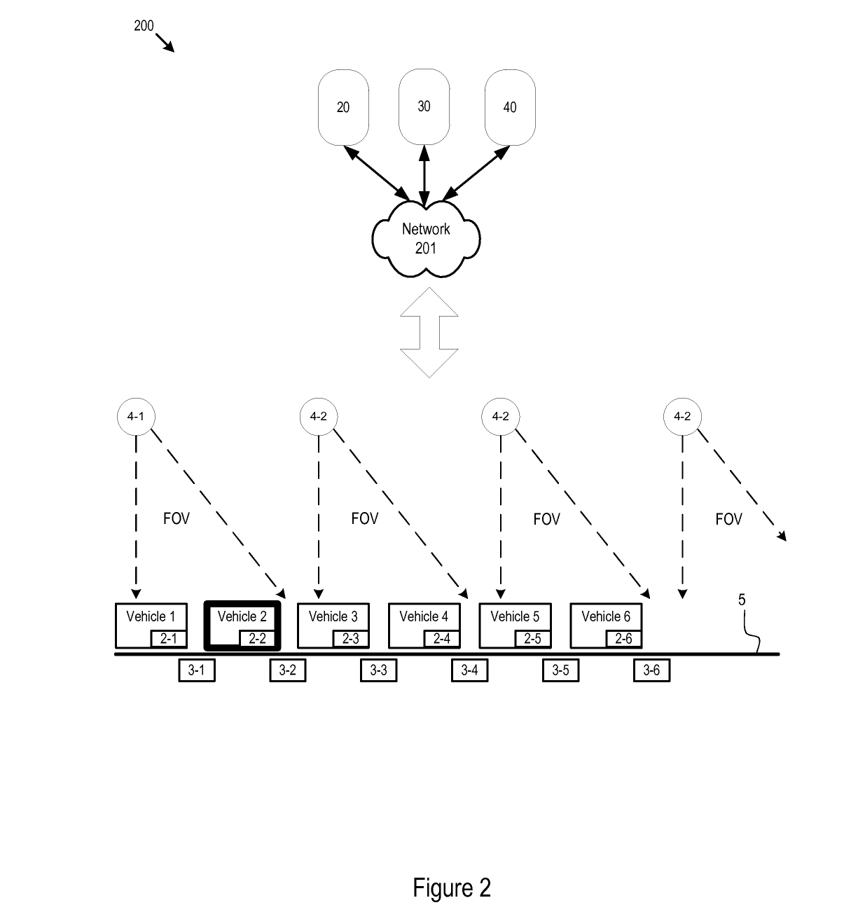

FIG. 2 illustrates a traffic condition detection system 200 according to some embodiments of the present invention. Traffic condition detection system 200 includes many components similar to those in traffic condition detection system 100. Each individual TDU illustrated in traffic condition detection system 200 operates in the same manner as described for traffic condition detection system 100 unless otherwise specified. However, instead of the MMM in vehicle 2 communicating with a TDU directly, as was the case in traffic condition detection system 100, in traffic condition detection system 200, the MMM communicates with a corresponding TDU server. The traffic condition detection system 200 is illustrated as including a GPS-based TDU server 20, a road sensor TDU server 30 and a traffic light TDU server 40.

For instance, if a user in vehicle 2 wishes to obtain traffic data from one or more of the GPS-based TDUs 2-1, 2-2, 2-3, 2-4, 2-5, 2-6, the MMM may transmit a request for traffic data to GPS-based TDU server 20. GPS-based TDU server 20 may obtain and store the traffic data corresponding to one or more GPS-based TDUs within the traffic condition detection system 200. The GPS-based TDU server 20 is able to obtain traffic data from the one or more GPS-based TDUs by communicating with the GPS satellite in order to track the one or more GPS-based TDUs. The GPS-based TDU server 20 includes a storage unit (e.g., memory) for storing the traffic data obtained by tracking the one or more GPS-based TDUs.

A user in vehicle 2 may input a request into the MMM in vehicle 2 to obtain traffic data from one or more of the GPS-based TDUs 2-1, 2-2, 2-3, 2-4, 2-5, 2-6 by transmitting the request to the GPS-based TDU server 20. The request is transmitted to the GPS-based TDU server 20 via network 201. Upon receiving the request, the GPS-based TDU server 20 accesses the requested traffic data corresponding to the appropriate GPS-based TDU(s) that is stored on the GPS-based TDU server 20. After accessing the requested traffic data, the GPS-based TDU server 20 transmits the traffic data back to the MMM in vehicle 2. Upon obtaining the traffic data from the GPS-based TDU server 20, the MMM may present the traffic data to the user according to any one of the methods described above. The MMM may also reference the traffic data as part of an analysis of traffic data in order to determine traffic conditions at specific locations. Further description is provided later in this disclosure.

As another example, if the user in vehicle 2 wishes to obtain traffic data from any one of road sensor TDUs 3-1, 3-2, 3-3, 3-4, 3-5, 3-6, the MMM may transmit a request for traffic data to road sensor TDU server 30. Road sensor TDU server 30 may access one or more road sensor TDUs in order to obtain the corresponding traffic data measured by the road sensor TDU. The road sensor TDU server 30 may then store the traffic data obtained from the one or more road sensor TDUs within the traffic condition detection system 200. The road sensor TDU server 30 is able to obtain traffic data from the one or more road sensor TDUs by communicating via the network 201. The road sensor TDU server 30 includes a storage unit (e.g., memory) for storing the traffic data obtained from the one or more road sensor TDUs.

A user in vehicle 2 may input a request into the MMM in vehicle 2 to obtain traffic data from one or more road sensor TDUs by transmitting the request to the road sensor TDU server 30. The request is transmitted to the road sensor TDU server 30 via the network 201. Upon receiving the request, the road sensor TDU server 30 accesses the requested traffic data corresponding to the appropriate road sensor TDU(s) that is stored on the road sensor TDU server 30. After accessing the requested traffic data, the road sensor TDU server 30 transmits the traffic data back to the MMM in vehicle 2. Upon obtaining the traffic data from the road sensor TDU server 30, the MMM may present the traffic data to the user according to any one of the methods described above. The MMM may also reference the traffic data as part of an analysis of traffic data in order to determine traffic conditions at specific locations. Further description is provided later in this disclosure.

As another example, if the user in vehicle 2 wishes to obtain video or traffic data from any one of traffic light TDUs 4-1, 4-2, 4-3, 4-4, the MMM may transmit a request for video or traffic data to traffic light TDU server 40. Traffic light TDU server 40 may access one or more traffic light TDUs in order to obtain video data recorded by the corresponding traffic light TDU. The traffic light TDU server 40 may then store the video data obtained from the one or more traffic light TDUs within the traffic condition detection system 200. The traffic light TDU server 40 may additionally perform video processing on the video data that is obtained from the one or more traffic light TDUs in order to generate traffic data corresponding to vehicle traveling speeds, and/or vehicle passing rates, and/or vehicle densities within the FOV of the respective traffic light TDU. In this way, video processing that is contemplated on the traffic light TDU server 40 is analogous to the video processing described above with reference to the traffic condition detection system 100. Accordingly, traffic light TDU server 40 is able to store video and/or traffic data corresponding to one or more of the traffic light TDUs in the traffic condition detection system 200. The traffic light TDU server 40 is able to communicate with the one or more traffic light TDUs via the network 201. The traffic light TDU server 40 includes a storage unit (e.g., memory) for storing the video data and/or traffic data obtained from the one or more traffic light TDUs.

A user in vehicle 2 may input a request into the MMM in vehicle 2 for video data obtained from one or more traffic light TDUs by transmitting the request to the traffic light TDU server 40. The user in vehicle 2 may also input a request into the MMM in vehicle 2 for traffic data that is generated from video data obtained from one or more traffic light TDUs by transmitting the request to the traffic light TDU server 40. In any case, the request is transmitted to the traffic light TDU server 40 via the network 201. Upon receiving the request, the traffic light TDU server 40 accesses the requested video or traffic data corresponding to the appropriate traffic light TCU(s) and transmits the video or traffic data back to the MMM in vehicle 2. Upon obtaining the video or traffic data from the traffic light TDU server 40, the MMM may present the video or traffic data to the user according to any one of the methods described above. The MMM may also subject the video data to video processing for generating traffic data, according to any one of the methods described above. The MMM may also reference the traffic data as part of an analysis of traffic data in order to determine traffic conditions at specific locations. Further description is provided later in this disclosure.

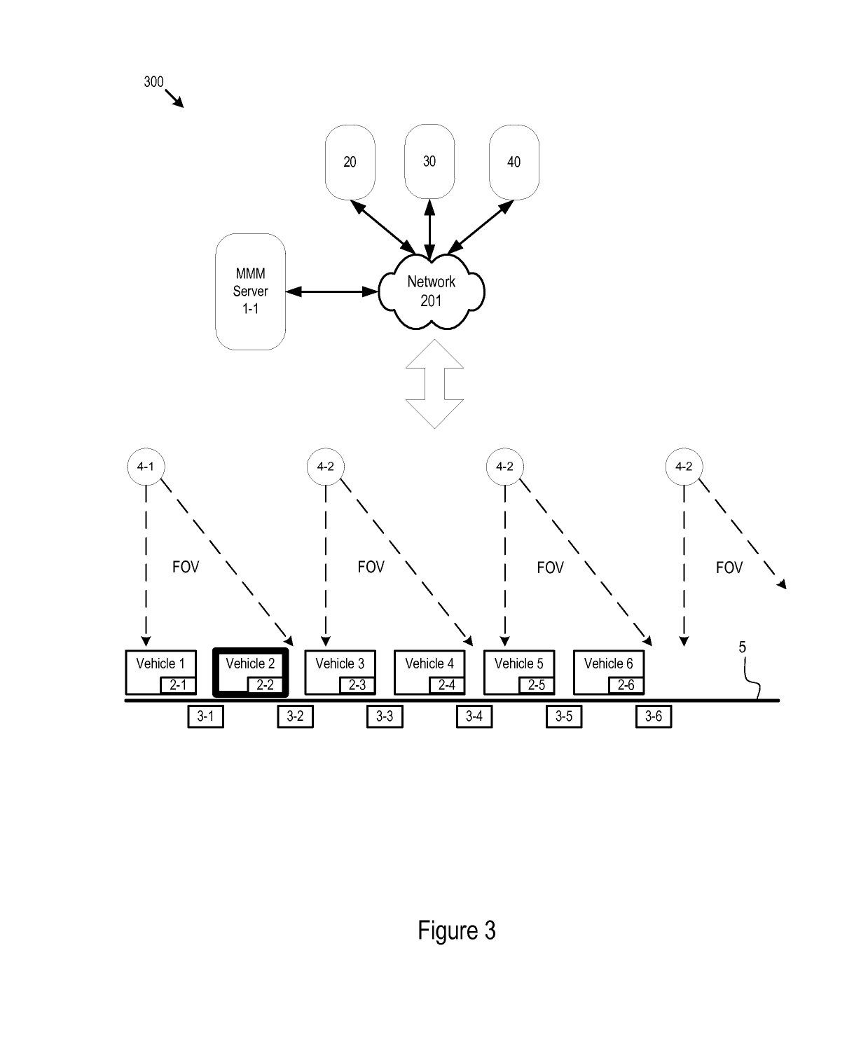

FIG. 3 illustrates a traffic condition detection system 300 according to some embodiments of the present invention. Traffic condition detection system 300 includes many components similar to those of traffic condition detection system 200. Each individual TDU illustrated in traffic condition detection system 300 operates in the same manner as described for traffic condition detection system 200 unless otherwise specified. However, instead of a vehicle located MMM executing the processes illustrated in FIGS. 4 and 5 as described above, the MMM server 1-1 may execute such processes.

In this way, the MMM that is included in vehicle 2 need not execute the processes described in FIGS. 4-5. Instead, the MMM may transmit a request to the MMM server 1-1 to execute such processes.

In some embodiments, the request transmitted by the MMM located on vehicle 2 may include instructions for accessing specific TDUs. Such TDU accessing instructions that are included in the request may be read by the MMM server 1-1 so that the MMM server 1-1 may identify the appropriate TDUs and/or TDU servers within the traffic condition detection system 300 to access. By accessing the appropriate TDUs and TDU servers identified in the request, the MMM server 1-1 may obtain the appropriate traffic data for executing the process also identified in the request.

In other embodiments, the MMM located on vehicle 2 may transmit the request for executing a process along with specific traffic data to be referenced during the execution of the process. The traffic data may be obtained from any one or more of the TDU servers 20, 30, 40 or individual TDUs 2-1, 2-2, 2-3, 2-4, 2-5, 2-6, 3-1, 3-2, 3-3, 3-4, 3-5, 3-6, 4-1, 4-2, 4-3, 4-4 or generated on the MMM itself.

FIG. 4A illustrates a flow chart 400 describing a process for detecting an end to a traffic congestion pattern, according to one embodiment of the invention. For exemplary purposes, a user is assumed to be located in a vehicle that is in a traffic congestion pattern (e.g., stuck in traffic). The process described by flow chart 400 may be processed, for example, on one of an MMM located on a vehicle, a traffic data collecting TDU, or a TDU server and an MMM server as described throughout this description.

At 401, a location for the user's vehicle is determined. The location of the vehicle may be determined, for example, according to a GPS-based TDU located in the vehicle. In some embodiments, the GPS-based TDU may be included in an MMM located in the vehicle.

At 402, the user may input information identifying an intended route into the MMM located in the vehicle. The MMM will receive the user input and determine the intended route based on the user input.

At 403, the MMM may access a TDU along the intended route and obtain traffic data from the accessed TDU. In some embodiments, the first TDU to be accessed may be the closest TDU to the vehicle. For instance, the MMM may access a traffic light TDU along the intended route that is closest to the user's vehicle and obtain video data from it. The MMM may then perform video processing on the obtained video data in order to generate traffic data. The traffic data may identify at least one of a rate of vehicles passing by a FOV of the traffic light TDU, a speed of vehicles passing by the FOV of the traffic light TDU and a density of vehicles within the FOV of the traffic light. Although the traffic data corresponding to the traffic light TDU is described above, any one or more of the TDUs described above may be accessed in order to obtain the corresponding traffic data at 403.

At 404, the obtained traffic data is analyzed by the MMM in order to determine whether an end to a traffic congestion pattern can be recognized. The flow chart 404 illustrated in FIG. 4B provides a more in depth look at the process at 404.

At 410, the traffic data from the accessed TDU is received.

At 411, the traffic data is analyzed and a traffic condition is determined based on the analysis.

For instance, if the MMM analyzes the traffic data from the traffic light TDU and determines that the rate of vehicles passing the FOV of the traffic light TDU is greater than a predetermined rate, the MMM may recognize an end to the traffic congestion pattern. In this way, the end to the traffic congestion pattern that the user is stuck in can be recognized to be within the location of the accessed traffic light TDU.

In addition, or alternatively, if the MMM analyzes the traffic data from the traffic light TDU and determines that the speed of vehicles passing the FOV of the traffic light TDU is greater than a predetermined speed, the MMM may recognize an end to the traffic congestion pattern. In this way, the end to the traffic congestion pattern that the user is stuck in can be recognized to be within the location of the accessed traffic light TDU.

In addition or alternatively, if the MMM analyzes the traffic data from the traffic light TDU and determines that the density of vehicles within the FOV of the traffic light TDU is less than a predetermined density, the MMM may recognize an end to the traffic congestion pattern. In this way, the end to the traffic congestion pattern that the user is stuck in can be recognized to be within the location of the accessed traffic light TDU.

In the case where a road sensor TDU is accessed at 403, if the MMM analyzes the traffic data from the road sensor TDU and determines that a speed of vehicles passing over the road sensor TDU is greater than a predetermined speed, the MMM may recognize an end to the traffic congestion pattern. In this way, the end to the traffic congestion pattern that the user is stuck in can be recognized to be within the location of the accessed road sensor TDU.

In addition or alternatively, if the MMM analyzes the traffic data from the road sensor TDU and determines that the rate of vehicles passing over the road sensor TDU is greater than a predetermined rate, the MMM may recognize an end to the traffic congestion pattern. In this way, the end to the traffic congestion pattern that the user is stuck in can be recognized to be within the location of the accessed road sensor TDU.

In the case where a GPS-based TDU is accessed at 403, if the MMM analyzes the traffic data from the GPS-based TDU and determines that a speed of vehicles traveling within a set location is greater than a predetermined speed, the MMM may recognize an end to the traffic congestion pattern. In this way, the end to the traffic congestion pattern that the user is stuck in can be recognized to be within the set location of GPS-based TCUs from which the traffic data is accessed from.

Then at 412, the traffic condition that is determined at 411 is returned.

Returning back to flow chart 400, if an end to the traffic congestion pattern is recognized from the obtained traffic data, at 406 the location of the end of the traffic congestion pattern is provided to the user.

However, if an end to the traffic congestion pattern is not recognized from the obtained traffic data at 404, then at 405 a next TDU is accessed and traffic data from the next accessed TDU is obtained. The traffic data obtained from the next TDU is then analyzed at 404 to determine whether an end to the traffic congestion pattern can be recognized from the traffic data. The next TDU that is accessed at 405 may be further away in distance from the previously accessed TDU. In this way, the process described by flow chart 400 may be able to locate the closest point at which the traffic congestion pattern that the user is stuck in ends.

FIG. 5A illustrates a flow chart 500 describing a process for detecting an end to a traffic congestion pattern, according to one embodiment of the invention. For exemplary purposes, a user is assumed to be located in a vehicle that is in a traffic congestion pattern (e.g., stuck in traffic). A part, or all, of the process described by flow chart 500 may be executed, for example, on one of an MMM located on a vehicle, a traffic data collecting TDU, a TDU server and an MMM server as described throughout this description.

At 501, a location for the user's vehicle is determined. The location of the vehicle may be determined, for example, according to a GPS-based TDU located in the vehicle. In some embodiments, the GPS-based TDU may be included in an MMM located in the vehicle.

At 502, the user may input information identifying an intended route into the MMM located in the vehicle. The MMM will receive the user input and determine the intended route based on the user input. In addition to the user input identifying the intended route, the user may also input a request to locate an end to the traffic congestion pattern that the user is currently stuck in.

At 503, the intended route information and the request information from the user's inputs are transmitted from the MMM to an external server. The external server may be, for example, the MMM server 1-1 illustrated in FIG. 3.

At 504, the intended route information and the request information are received by the external server.

At 505, a first TDU server may be accessed by the external server based on the intended route and request information received by the external server. The request information may include information identifying specific TDUs to access. In such cases, the external server may access the TDU server corresponding to the TDUs that are identified in the request to be accessed. Alternatively, the external server may analyze the intended route information and determine which TDUs are located along, or closest to, the intended route. The external server may then access the TDU server that correlates to the TDUs that are determined to be located along, or closest to, the intended route.

The TDU server that is accessed may store traffic data that has been obtained from corresponding TDUs within a common traffic condition detection system as described above. For instance, if the TDU server is the road sensor TDU server 30, then the road sensor TDU server 30 will store traffic data obtained from individual road sensor TDUs throughout the traffic condition detection system.

In any case, after accessing the first TDU server the traffic data stored in the TDU server may be obtained. For instance, if the external server were to access the traffic light TDU server 40 at 505, the external server may then obtain video data that is stored on the accessed traffic light TDU server 40. The external server may then perform video processing on the obtained video data in order to generate traffic data. The traffic data may identify at least one of a rate of vehicles passing by a FOV of a traffic light TDU, a speed of vehicles passing by the FOV of a traffic light TDU, and a density of vehicles within the FOV of a traffic light. Although the video processing is described as being executed on the external server, in some embodiments the video processing may be executed on the traffic light TDU server 40. In such embodiments, the external server does not need to perform video processing on video data in order to generate the traffic data. Instead, the external server may access the traffic light TDU server 40 and obtain the traffic data directly from the accessed traffic light TDU server 40.

It should also be noted that although 505 is described as accessing the traffic light TDU server 40, any other available TDU server may be accessed based on the intended route and request information received by the external server at 504.

At 506, a determination is made whether to access another TDU server. In some embodiments this determination may be based on whether an end to the traffic congestion pattern can be recognized based on the traffic data obtained from the first TDU server.

In some embodiments a predetermined number of available TDU servers may be accessed before making the determination at 506 that another TDU server is not to be accessed. For example, all available TDU servers may be accessed in order to obtain all available traffic data. As another example, two available TDU servers may be accessed before making the determination at 506 that another TDU server is not to be accessed. The greater the number of TDU servers that are accessed in order to obtain traffic data stored on the accessed TDU servers may be correlated to an accuracy of a recognized end to the congested traffic pattern. The more traffic data that is obtained from across different TDU servers not only increases the amount of traffic data that is being processed, but it also diversifies the type of traffic data that is obtained for analysis. In this way the more TDU servers that are accessed and the more traffic data that is obtained from the accessed TDU servers may provide for a more accurate recognition to the end of the traffic congestion pattern. Conversely, analyzing a larger amount of obtained traffic data may require greater processing power and require a longer period of time to process the traffic data. The value of the predetermined number may therefore take into account the various competing factors described.

If the determination at 506 calls for the external server to access a next TDU server, the next TDU server is accessed at 507. The traffic data that is stored on the next TDU server is also obtained at 507.

When there are no more TDU servers to access, at 508 all of the obtained traffic data will be analyzed in order to locate an end to the traffic congestion pattern that the user's vehicle is currently stuck in.

FIG. 5B illustrates a flow chart 508 that provides a more in depth look at the process at 508.

At 510, each traffic data that is obtained from each respective TDU server is analyzed. The analysis of the traffic data is made to determine a traffic condition at various locations along the intended route of the user. The traffic data obtained from a first TDU server may provide a unique perspective on a traffic condition pattern from traffic data obtained from a second TDU server. This is because each type of TDU is able to measure and obtain traffic data according to different methods.

The analysis of traffic data may be made according to the analysis of traffic data described with respect to flow chart 400 and 404 above.

At 511, a traffic condition that is determined based on the analysis of traffic data obtained from the first TDU server is supplemented by a traffic condition that is determined based on the analysis of traffic data obtained from another TDU server. The traffic conditions may be location specific. For instance, traffic data from the road sensor TDU 30 server may recognize that road sensor TDUs along a one mile stretch of the user's intended route are measuring traffic congestion patterns indicative of progressively milder traffic congestion that finally clear up at the end of the one mile stretch. The one mile stretch of such borderline traffic congestion is a rough estimate of where the traffic congestion pattern ends. However a more accurate location for the end of the traffic congestion pattern may be determined by supplementing this traffic condition recognition with traffic data that is obtained from another TDU server. For example, to supplement this traffic condition finding that is based only on traffic data obtained from the road sensor TDU server 30, traffic data from the traffic light TDU server 40 may be referenced. Specifically, traffic data obtained from traffic light TDUs from within the one mile stretch of borderline traffic congestion recognized by the road sensor TDUs may be obtained from the traffic light TDU server 40. By then analyzing the specific traffic data obtained from the traffic light TDUs along the one mile stretch, the exact traffic light at which the traffic congestion pattern ends may be recognized.

At 512, by supplementing traffic conditions based on traffic data from one TDU server with traffic data obtained from one or more TDU servers, a traffic condition at one or more locations along the user's intended route may be determined.

After determining a traffic condition at one or more locations along the user's intended path according to the analyses described in 510-512, at 513, an end to the traffic congestion pattern along the user's intended route may be located.

In this way, a traffic condition that is determined from traffic data obtained from one TDU server may be supplemented by traffic data obtained from one or more other TDU servers.

Returning to flow chart 500, if at 508 an end to the traffic congestion pattern is recognized from the obtained traffic data, at 509 the location of the end of the traffic congestion pattern is provided to the user by transmitting the location information to the MMM located on the user's vehicle.

FIG. 6 illustrates a block diagram for an MMM 600 according to one embodiment of the invention. The MMM 600 may include a storage unit 601, processor 602, communications interface 603, and, optionally, a GPS-based traffic detection unit (TDU) 604. MMM 600 may be configured according to any number of user requirements with respect to communication capabilities, data transfer configurations, data collection configurations, and other configurations. MMM 600 may also collect any vehicle data, such as performance statistics, route information, position data, traffic data, and others. In one example, MMM 600 may include telemetry functionality to collect and/or send vehicle data. These telemetry functions may include measurements or records of speed, direction, acceleration, pitch, yawl, and roll, and measurements or records of rate of change for speed, direction, acceleration, pitch, yawl, and roll. Applications may be installed on MMM 600 to facilitate, support, or perform any of the methods or steps to the methods described herein. For example, applications may be installed to process information, e.g., speed measurements or video signals, to determine traffic information. One example of MMM 600 is the Openmatics© on-board unit provided by ZF Friedrichshafen AG.

Methods or processes may be implemented, for example, using a processor and/or instructions or programs stored in a memory. Specific components of the disclosed embodiments may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters, databases, and other data structures may be separately stored and managed, may be incorporated into a single memory or database, or may be logically and physically organized in many different ways. Programs or instruction sets may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method for determining a traffic condition by a multi-media module installed on a vehicle, the method comprising:
receiving a user input;
determining an intended route for the vehicle based on the user input;
accessing a traffic detection unit located at a first location along the intended route;
obtaining traffic data from the traffic detection unit; and
analyzing the traffic data to determine a traffic condition.

2. The method of claim 1, wherein the traffic detection unit is a road sensor that measures a speed of a vehicle passing by the road sensor.

3. The method of claim 2, wherein analyzing the traffic data comprises determining a congestion traffic condition does not occur at the first location when the speed of a predetermined number of vehicles detected by the road sensor is above a predetermined speed.

4. The method of claim 1, wherein the traffic detection unit is a road sensor that measures a rate at which vehicles pass by the road sensor.

5. The method of claim 4, wherein analyzing the traffic data comprises determining a congestion traffic condition does not occur at the first location when the rate at which vehicles pass as detected by the road sensor is below a predetermined threshold.

6. The method of claim 1, wherein the traffic detection unit is a traffic camera that records a traffic condition on a road.

7. The method of claim 6, wherein analyzing the traffic data comprises processing video data that is recorded by the traffic camera and determining a congestion traffic condition does not occur within a field of view of the traffic camera when a rate at which vehicles detected from the processed video data pass within the field of view of the camera exceeds a predetermined rate.

8. The method of claim 6, wherein analyzing the traffic data comprises processing video data that is recorded by the traffic camera and determining a congestion traffic condition does not occur within the field of view of the camera when a density of vehicles detected from the processed video data within the field of view of the camera falls below a predetermined density.

9. The method of claim 6, wherein analyzing the traffic data comprises processing video data that is recorded by the traffic camera and determining a congestion traffic condition does not occur within the field of view of the camera when a speed at which vehicles detected from the processed video data pass within the field of view of the camera exceeds a predetermined speed.

10. The method of claim 1, wherein the traffic detection unit is a GPS device that detects a location and speed of the GPS device.

11. The method of claim 10, wherein obtaining traffic data comprises obtaining vehicle speed data of vehicles located within a predetermined distance from the vehicle, and
wherein analyzing the traffic data comprises processing the vehicle speed data and determining a congestion traffic condition occurs within the predetermined distance from the vehicle when the vehicle speed data indicates a speed of vehicles within the predetermined distance of the vehicle are below a predetermined threshold.

12. The method of claim 1, further comprising accessing a traffic detection unit at a second location along the intended route when a congestion traffic condition is detected based on the traffic data obtained from the traffic detection unit located at the first location.

13. A method for processing a request for a traffic condition, the method comprising:
receiving the request for a traffic condition from a multi-media module installed on a vehicle;
determining a location of the vehicle;
receiving a user input, and determining an intended route for the vehicle based on the user input;
accessing a traffic detection server, and obtaining traffic data from the traffic detection server;
analyzing the traffic data in order to determine a traffic condition detected by the traffic detection server, and
transmitting the determined traffic condition to the multi-media module.

14. A multi-media module for locating an end to a traffic congestion pattern, the multi-media module comprising:
a processor configured to:
determine an intended route for the user based on the user input;
access a traffic detection unit located at a first location along the intended route, and obtain traffic data from the traffic detection unit;
analyze the traffic data in order to determine a traffic condition detected by the traffic detection unit, and
present the determined traffic condition.

15. The multi-media module of claim 14 further comprising an interface configured to receive a user's input, the interface in communication with the processor.

16. The multi-media module of claim 14, wherein the obtained traffic data comprises video data recorded by a traffic camera within a field of view of the traffic camera, and
wherein the processor is configured to analyze the video data to determine whether a congestion traffic condition occurs within the field of view of the traffic camera.

17. The multi-media module of claim 16, wherein the processor is configured to determine a congestion traffic condition does not occur within the field of view of the traffic camera when a rate at which vehicles detected from the video data pass within the field of view of the traffic camera surpasses a predetermined rate.

18. The multi-media module of claim 16, wherein the processor is configured to determine a congestion traffic condition does not occur within the field of view of the traffic camera when a speed at which vehicles detected from the video data pass within the field of view of the traffic camera surpasses a predetermined speed.

19. The multi-media module of claim 18, wherein the processor is configured to determine a congestion traffic condition does not occur within the field of view of the traffic camera when a density of vehicles detected from the video data within the field of view of the traffic camera falls below a predetermined density.

20. The multi-media module of claim 16, wherein the processor is further configured to access a traffic detection unit located at a second location along the intended route when a congestion traffic condition is detected at the first location based on the traffic data obtained from the traffic detection unit located at the first location.
